(19) United States
(12) Patent Application Publication
(10) Pub. No.: US 2011/0108293 A1
(43) Pub. Date: May 12, 2011

(54) Fire Fighting System

(76) Inventors: Markku Vuorisalo, Helsinki (FI); Jean-Paul Lamers, Nijmegen (NL)

(21) Appl. No.: 13/001,446

(22) PCT Filed: Jun. 22, 2009
(86) PCT No.: PCT/FI2009/050553

§ 371 Date: Dec. 27, 2010

(30) Foreign Application Priority Data
Jun. 26, 2008 (FI) 20085651

(51) Int. Cl. A62C 3/07; A62C 35/62; A62C 35/20

(52) U.S. Cl. 169/62; 169/17

(57) ABSTRACT

A fire fighting system comprising a fixed fire fighting system with a plurality of spray heads (15) as well as means (10, 12, 14A, 14B, 14C) for leading a fire fighting medium from a fire fighting medium source (11) to the spray heads (15) as well as at least one pump means (10) between the fire fighting medium source (11) and the spray heads (15), which system further comprises spray heads (5) arranged in a mobile unit (1), such as a vehicle, a carriage connectable to a vehicle, a train or a train car, and means (2, 4) for leading a fire fighting medium to the spray heads (5). The system comprises means (7, 7′, 8, 9) for connecting the spray heads (5) of the mobile unit (1) to the circuit of the fixed fire fighting system.

### BACKGROUND OF THE INVENTION

The invention relates to a fire fighting system according to the preamble of claim 1, comprising a fixed fire fighting system with a plurality of spray heads as well as means for leading a fire fighting medium from a fire fighting medium source to the spray heads as well as at least one pump means between the fire fighting medium source and the spray heads, which system further comprises spray heads arranged in a mobile unit, such as a vehicle, a carriage connectable to a vehicle, a train or a train car, and means for leading a fire fighting medium to the spray heads.

Fixed fire fighting systems for protecting stationary spaces are known from the fire safety technology. On the other hand, fire fighting systems for protecting, in the first place, the interior of a mobile unit, such as rolling stock, are known. WO 0126739 describes one system. EP1611925A1 describes another system for a mobile unit.

A disadvantage related to the systems used in mobile units is that they typically give protection for quite a short time. Besides, they typically are activated by a signal from a fire detector placed in the mobile unit or by manually activating the system inside them. This is a problem especially when the mobile units are temporarily out of service, such as at a car depot or station.

However, they are exactly the mobile units located at a car depot or station that have the highest risk of fire because different kinds of service measures possibly involving a higher risk of fire are taken there.

The aim of this invention is to provide a totally new solution for substantially raising the fire protection level of mobile units.

### BRIEF DESCRIPTION OF THE INVENTION

The invention is based on the idea that each mobile unit provided with fire fighting means temporarily is connected to the trunk pipe of a fixed fire fighting system, it thus being under enhanced fire protection.

The fire fighting system according to the invention is primarily characterized in that the system comprises means for connecting the spray heads of a mobile unit to a fixed fire fighting system.

The fire fighting system according to the invention is further characterized by what is set forth in Claims 2 to 10.

The solution according to the invention has several significant advantages. A significant increase in the fire safety of stopped mobile units can be achieved by temporarily connecting each mobile unit to the pipework of a fixed fire fighting system. Then the mobile unit is protected not only by the fixed fire fighting system of the station or the like but also by the mobile unit's own spray heads. By connecting the mobile unit to the fixed system using a quick connector that closes the medium connection from the trunk pipe to the outlet of the connecting unit's connector an easy-to-use and quick solution is achieved that allows the use of a pre-pressurized trunk pipe. The fire fighting system according to invention is useful in many different applications.

In the following the invention will be described by means of an example with reference to the accompanying drawing wherein

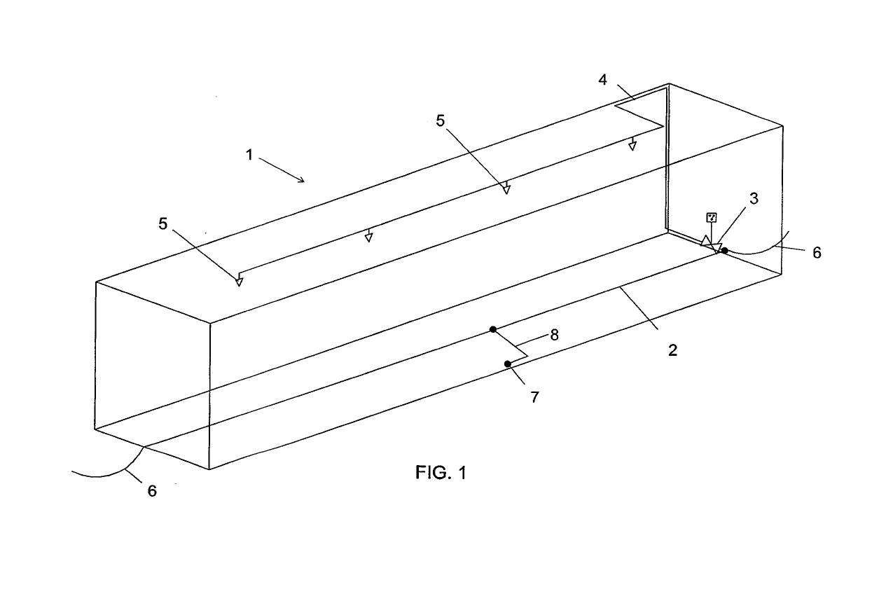

FIG. 1 is a schematic view of an embodiment of the fire fighting system according to the invention in a mobile unit,

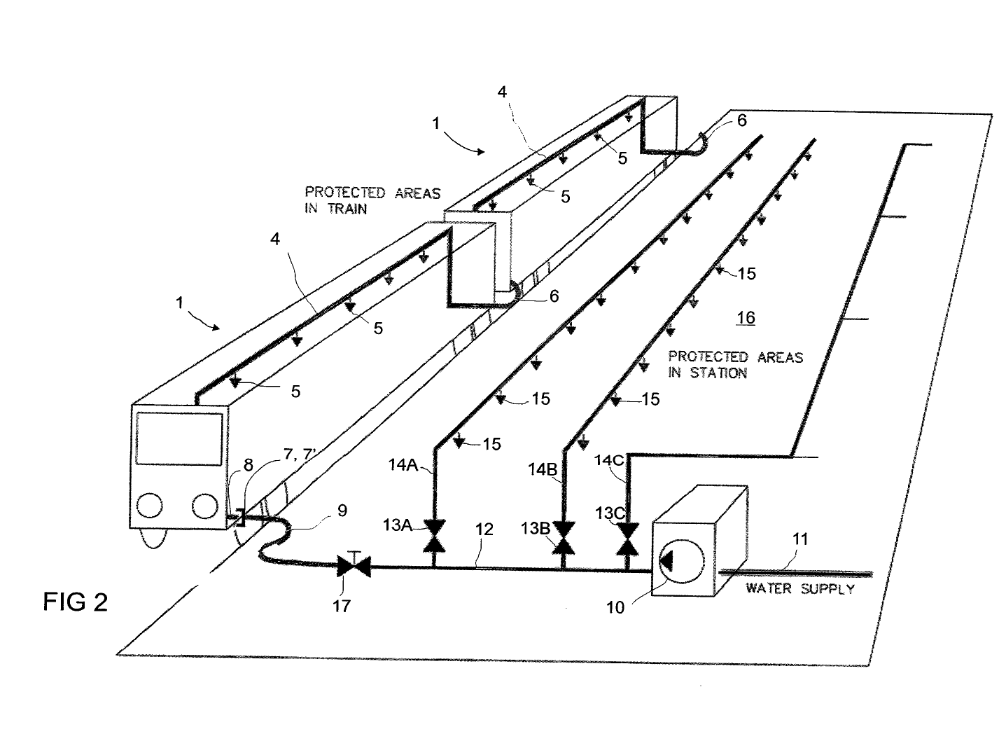

FIG. 2 is a simplified schematic view of an embodiment of the fire fighting system according to the invention.

### DETAILED DESCRIPTION OF THE INVENTION

FIGS. 1 and 2 are schematic views of solutions applying the fire fighting system according to the invention. FIG. 1 shows a mobile unit 1 provided with a fire fighting system comprising at least spray nozzles 5 arranged inside the unit as well as a fire fighting medium passage, such as pipelines 4 from a fire fighting medium source to them. FIG. 1 shows one mobile unit or a section thereof, such as a train car having one fire fighting medium main transfer pipe 2 to which the pipeline 4 leading to the nozzles is connected. In the embodiment of the Figure, a valve member 3 is arranged in the pipeline leading to the nozzles. The main transfer pipe 2 is connected to the fire fighting medium source of the mobile unit 1 that is not shown in FIG. 1. The fire fighting system sections of the mobile units 1, such as train cars, are connected to each other by a connecting member 6, such as by a flexible hose member. The fire fighting medium source of the mobile unit 1 may be located in another mobile unit, such as in another car, instead of the space to be protected. According to another embodiment, the mobile unit may only have ready-to-use pipework and spray heads but not a fire fighting medium source of its own. In this case, the mobile unit 1 is fire-protected only when it is connected to a fixed external fire fighting system.

FIG. 2 shows a combination wherein the fire fighting medium passages 4 in the mobile unit 1, leading to the nozzles 5 intended especially for fire-protecting the interior thereof, are temporarily connected to a supply line 12 of a fixed fire fighting system external to the mobile unit 1. Naturally, the fire fighting system also comprises a fire fighting medium source 11 and means for leading the fire fighting medium from the medium source to the trunk pipe 12 and, at least upon the activation of the system, further to the spray heads 15. The medium source 11 is shown in simplified form. The means 10 used for transferring the medium, such as a pump means, is also shown in simplified form.

In principle, the pump means 10 may be any suitable pump means. Alternatively, or in addition to the pump means, another pressure source may be used for supplying the fire fighting medium.

In a preferred embodiment, the means for supplying the fire fighting medium have a feature for maintaining a stand-by pressure in the supply pipe 12 in a way known per se. When a liquid, or a mixture of a liquid and gas, is used as the fire fighting medium, fire fighting medium supplying devices used in the HI-FOG® fire fighting systems of Marioff Corporation Ltd., such as pumps and pressure medium sources, can be used. The spray head that is a sprinkler head, for example, can be a spray head especially intended for producing liquid mist, similar to the one disclosed in WO 01/45799.

As an example, FIG. 2 shows two mobile units 1, such as rail traffic units, for instance two subway cars, coupled to each other as well as parked and connected to the trunk pipe 12 by means of a flexible hose means 9 and a connecting unit 7, 7′. In FIG. 2, a plurality of pipelines 14A, 14B, 14C leading to the protected areas are connected to the trunk pipe of the fixed fire fighting system and provided with spray heads 15. Each of the pipelines 14A, 14B, 14C is provided with a valve means 13A, 13B, 13C, i.e. with a so-called section valve.

The mobile units 1 comprise fire fighting means 2, 3, 4, 5, such as at least one spray head 5, especially a sprinkler head, and pipe means 2, 4, 6 for leading a fire fighting medium to the spray head. The fire fighting means are arranged to be connected to a larger fixed fire fighting system, which fire fighting system has at least one trunk pipe 12 and at least one connecting point 17 for connecting the fire fighting means 4, 5 of the mobile unit to the trunk pipe, as well as a fire fighting medium source 11 and a means for leading the fire fighting medium from the medium source to the spray head. A flexible hose 9 can be arranged at the connecting point, which then is connected at the other end 7′, by means of a quick connector, for example, to the connecting point 7 connecting to the fire fighting means of the mobile unit.

Typically, an aqueous liquid, and/or a mixture of an aqueous liquid and gas, is used as the fire fighting medium. The spray heads spray fire fighting medium mist, especially water mist. The droplet size (Dv 90) of the fire fighting medium mist is typically less than 200 micrometers.

The fire fighting medium is sprayed with a high pressure which preferably is 10 to 300 bar. Typically, a pump unit having a constant pressure pump is used in the fixed fire fighting system.

The invention thus relates to a fire fighting system comprising a fixed fire fighting system with a plurality of spray heads 15 as well as means 10, 12, 14A, 14B, 14C for leading a fire fighting medium from a fire fighting medium source 11 to the spray heads 15 as well as at least one pump means 10 between the fire fighting medium source 11 and the spray heads 15, which system further comprises spray heads 5 arranged in a mobile unit 1, such as a vehicle, a carriage connectable to a vehicle, a train or a train car, and means 2, 4 for leading a fire fighting medium to the spray heads 5. The system comprises means 7, 7′, 8, 9 for connecting the spray heads 5 of the mobile unit 1 to the circuit of the fixed fire fighting system.

According to a preferred embodiment, the mobile unit 1 is a rail vehicle and/or a car connected to a rail vehicle, such as a subway train and/or a subway train car, or a train and/or a train car.

According to a preferred embodiment, the spray heads of the mobile unit 1. are connected to a pipeline 4 which, in an inactive state, is arranged to be a so-called dry pipe.

According to an embodiment, the fixed fire fighting system is arranged in a space where the mobile unit 1 is parked.

Typically, the fixed fire fighting system is arranged in a space that is a tunnel, railway station, subway station, car depot or the like.

According to still another embodiment, a flexible hose 9 is arranged between the fire fighting system section of the mobile unit 1 and the fixed fire fighting system section.

According to another embodiment, the fire fighting system section of the mobile unit 1 and the fixed fire fighting system section are connected to each other by a quick connector 7, 7′.

According to still another preferred embodiment, the fire fighting system is arranged to spray fire fighting medium mist, especially water mist, or a mixture of water mist and gas, when it is activated.

According to another preferred embodiment, the mobile unit 1 has an independent fire fighting system, the fire fighting medium supply pipe 12 of the fixed fire fighting system being arranged to be connected to the fire fighting medium supply pipe 6 thereof.

According to still another preferred embodiment, the spray heads 5 of the mobile unit 1 are arranged to spray into the mobile unit 1 when they are activated.

The fire fighting system according to the invention has many applications. Its natural applications include subway systems, for example, wherein the fire fighting systems of the stations and/or the tunnels are enabled to temporarily connect a subway car to the fixed fire fighting system. Naturally, the solution according to invention also is useful for other similar objects, such as trains or other vehicles. Using the system also in a situation involving a moving mobile unit 1 on fire can be considered. Then the mobile unit 1 is stopped at the nearest connecting point and connected to the fixed fire fighting system.

A person skilled in the art understands that the invention is not limited to the above-described embodiments but it may vary within the scope of the accompanying Claims. If necessary, characteristics set forth in the description together with other characteristics also can be used separately from each other.

1. A fire fighting system comprising a fixed fire fighting system with a plurality of spray heads (15) as well as means (10, 12, 14A, 14B, 14C) for leading a fire fighting medium from a fire fighting medium source (11) to the spray heads (15) as well as at least one pump means (10) between the fire fighting medium source (11) and the spray heads (15), which system further comprises spray heads (5) arranged in a mobile unit (1), such as a vehicle, a carriage connectable to a vehicle, a train or a train car, and means (2, 4) for leading a fire fighting medium to the spray heads (5), characterized in that the system comprises means (7, 7′, 8, 9) for connecting the spray heads (5) of the mobile unit (1) to the circuit of the fixed fire fighting system.

2. A fire fighting system as defined in claim 1, characterized in that the mobile unit (1) is a rail vehicle and/or a car connected to a rail vehicle, such as a subway train and/or a subway train car, or a train and/or a train car.

3. A fire fighting system as defined in claim 1, characterized in that the spray heads of the mobile unit (1) are connected to a pipeline (4) which, in an inactive state, is arranged to be a so-called dry pipe.

4. A fire fighting system as defined in claim 1, characterized in that the fixed fire fighting system is arranged in a space where the mobile unit (1) is parked.

5. A fire fighting system as defined in claim 4, characterized in that the fixed fire fighting system is arranged in a space that is a tunnel, railway station, subway station, car depot or the like.

6. A fire fighting system as defined in claim 1, characterized in that a flexible hose (9) or the like is arranged between the fire fighting system section of the mobile unit (1) and the fixed fire fighting system section.

7. A fire fighting system as defined in claim 1, characterized in that the fire fighting system section of the mobile unit (1) and the fixed fire fighting system section are connected to each other by a quick connector (7, 7′).

8. A fire fighting system as defined in claim 1, characterized in that the fire fighting system is arranged to spray fire fighting medium mist, especially water mist, or a mixture of water mist and gas, when it is activated.

9. A fire fighting system as defined claims 1, characterized in that the mobile unit (1) has an independent fire fighting system, the fire fighting medium supply pipe (12) of the fixed fire fighting system being arranged to be connected to the fire fighting medium supply pipe (6) thereof.

10. A fire fighting system as defined in claims 1, characterized in that the spray heads (5) of the mobile unit (1) are arranged to spray into the mobile unit (1) when they are activated.
